(19) United States
(12) Patent Application Publication
(10) Pub. No.: US 2023/0177138 A1
(43) Pub. Date: Jun. 8, 2023

(54) IDENTITY VERIFICATION UTILIZING UPLOADED CONTENT AND TRUST SCORE

(71) Applicant: Prove Identity, Inc., New York, NY (US)

(72) Inventor: Ryan Alexander, Snohomish, WA (US)

(21) Appl. No.: 18/076,074

(22) Filed: Dec. 6, 2022

Related U.S. Application Data
(60) Provisional application No. 63/286,951, filed on Dec. 7, 2021.

(51) Int. Cl. G06F 21/36; G06F 21/57

(52) U.S. Cl. CPC G06F 21/36; G06F 21/57; G06F 2221/033

(57) ABSTRACT

Briefly, example methods, apparatuses, and/or articles of manufacture may be implemented to perform identity verification utilizing uploaded content and a trust score. One embodiment may include obtaining, via a communications network, an identifier of a communications device. The method may continue with transmitting, via the communications network, a message to request an upload of a captured image of first content and to request an upload of a captured image of second content. The method may continue with determining whether parameters extracted from the uploaded captured image of the first content match parameters extracted from the uploaded second content. The method may continue with generating an authentication signal for transmission to a client computing resource.

### BACKGROUND

### 1. Field

The present disclosure relates generally to verifying and/or authenticating individuals and/or other entities that may engage in financial transactions utilizing a communications device.

### 2. Information

The World Wide Web or simply the Web, as enabled by Internet computing, routing, and/or wireless transmission resources, has grown rapidly in recent years at least partially in response to the relative ease with which a wide variety of transactions can be performed or enabled via the Internet. As a consequence of widely available Internet connections, including connections to the Internet facilitated by wireless mobile communication services, for example, a mobile subscriber may shop and/or purchase virtually any product or service utilizing a handheld communications device. However, in such an environment, in which electronic, Internet-based commerce has become increasingly common, occurrences of fraud and deception, unfortunately, can also occur.

In addition to facilitating communications among devices having a primary purpose that relates to providing communication services, such as mobile cellular communications devices, the Web also facilitates communication among devices providing other functionalities, such as appliances, industrial, commercial, and household machines, control devices, sensors, etc. In such environments, which include an “Internet of things” (IOT) environment, as well as environments involving devices designed primarily for communications, instances of fraud and deception may bring about theft of financial assets, intrusion by unauthorized parties into a user's home network, theft of privileged content, financial and/or credit fraud, and so forth. To reduce a likelihood of fraud, theft, or intrusion by unauthorized parties, fraud-detection and/or user authentication processes may be implemented. Thus, it may be appreciated that reduction in the instances of fraud and deception, which may involve, for example, use of various types of communications devices, continues to be an active area of investigation.

### SUMMARY

One general aspect includes a method including obtaining, via a communications network, an identifier of a communications device. The method also includes transmitting, via the communications network, a message to request an upload of a captured image of first content and to request an upload of a captured image of second content. The method also includes determining whether parameters extracted from the uploaded captured image of the first content match parameters extracted from the uploaded second content. The method also includes generating an authentication signal for transmission to a client computing resource.

In particular embodiments, the identifier of the communications device includes a mobile telephone number. In particular embodiments, the transmitted message includes a link to a resource that is under the control and/or direction of an identity verifier. In particular embodiments, the first content includes a user document. In particular embodiments, the user document includes a government-issued identification document. In particular embodiments, the government-issued identification document includes a driver's license. In particular embodiments, the government-issued identification document includes a passport. In particular embodiments, the second content includes an image of a portion of the user's person. In particular embodiments, the portion of the user's person includes at least a portion of the user's face. In particular embodiments, the method may, further include determining that the identifier of the communications device includes an identifier stored in a database accessible to an identity verifier. In particular embodiments, the parameters extracted from the user-uploaded captured image of the first content correspond to parameters of a subscriber identified by the identifier stored in the database. In particular embodiments, the identified subscriber corresponds to a holder of an account with respect to the communications device. In particular embodiments, generating the authentication signal is based, at least in part, on a trust score computed for the identified subscriber. In particular embodiments, the authentication signal is based, at least in part, on a trust score being computed responsive to a detection of a discrepancy detected between the parameters extracted from the first content and the parameters extracted from the upload of the captured image of the second content. In particular embodiments, the trust score is computed responsive to at least one of: determining validity of the user-uploaded captured image of the first content, detection of a discrepancy between the parameters extracted from the first content and the parameters of the subscriber identified by the identifier stored in the database, and detecting a risk associated with the subscriber identifier.

In another general aspect, an apparatus includes at least one processor coupled to at least one memory device to obtain, via a communications network, an identifier of a communications device. The at least one processor coupled to the at least one memory device may additionally transmit, via the communications network, a message to request an upload of a captured image of first content and to request an upload of a captured image of second content. The at least one processor coupled to the at least one memory device may additionally determine whether parameters extracted from the uploaded captured image of the first content match parameters extracted from the uploaded second content. The processor coupled to the at least one memory device may additionally generate an authentication signal for transmission to a client computing resource.

In particular embodiments, the identifier of the communications device may include a mobile telephone number. In particular embodiments, the transmitted message includes a link to a resource that is under the control and/or direction of an identity verifier. In particular embodiments, the first content may include a government-issued identification document. In particular embodiments, the second content may include an image of a portion of the user's person in which the portion of the user's person includes at least a portion of the user's face. In particular embodiments, the parameters extracted from the user-uploaded captured image of the first content correspond to parameters of a subscriber identified by an identifier stored in the database and in which generation of the authentication signal is based, at least in part, on a trust score computed for the identified subscriber.

Another general aspect includes an article that includes a non-transitory computer-readable medium including instructions encoded thereon which, in response to being executed by a computer processor coupled to at least one memory device, instruct the computer processor coupled to the at least one memory device to obtain, via a communications network, an identifier of a communications device and to transmit, via the communications network, a message to request an upload of a captured image of first content and to request an upload of a captured image of second content. The encoded instructions may additionally operate to determine whether parameters extracted from the uploaded captured image of the first content match parameters extracted from the uploaded second content. The encoded instructions may additionally operate to generate an authentication signal for transmission to a client computing resource.

In particular embodiments, the identifier of the communications device includes a mobile telephone number. In particular embodiments, the transmitted message includes a link to a computing resource that is under the control and/or direction of an identity verifier. In particular embodiments, the first content includes or corresponds to a government-issued identification document. In particular embodiments, the second content includes an image of a portion of the user's person and wherein, the portion of the user's person includes at least a portion of the user's face. In particular embodiments, the parameters extracted from the user-uploaded captured image of the first content correspond to parameters of a subscriber identified by an identifier stored in a database, and wherein generating the authentication signal is based, at least in part, on a trust score computed for the identified subscriber.

### BRIEF DESCRIPTION OF THE DRAWINGS

Claimed subject matter is particularly pointed out and distinctly claimed in the concluding portion of the specification. However, both as to organization and/or method of operation, features, and/or advantages thereof, it may best be understood by reference to the following detailed description if read with the accompanying drawings in which:

FIG. 1 is a diagram of a communications infrastructure that includes both wireless and wireline communications devices, according to various embodiments.

FIG. 2 is a diagram of a subscriber in possession of a communications device to facilitate identity verification utilizing uploaded content and a trust score, according to an embodiment.

FIG. 3 is a diagram of a subscriber obtaining first and second content to facilitate identity verification utilizing uploaded content and a trust score, according to an embodiment.

FIG. 4 shows a flowchart for a process of identity verification utilizing uploaded content and a trust score, according to an embodiment.

FIG. 5 shows a flowchart for a process of identity verification utilizing a communications device to upload content to an identity verifier, according to an embodiment.

FIG. 6 is a diagram showing a computing environment, according to an embodiment.

Reference is made in the following detailed description to the accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases in various places throughout this specification, are not necessarily intended to refer to the same implementation and/or embodiment or to any one particular implementation and/or embodiment. Furthermore, it is to be understood that particular features, structures, characteristics, and/or the like described, are capable of being combined in various ways in one or more implementations and/or embodiments and, therefore, are within intended claim scope. In general, for the specification of a patent application, these and other issues have a potential to vary in a particular context of usage. In other words, throughout the disclosure, particular context of description and/or usage provides guidance regarding reasonable inferences to be drawn; however, likewise, the term “in this context” in general without further qualification refers at least to the context of the present patent application.

As previously alluded to, devices that communicate electronically, such as wireless mobile communications devices, voice over Internet protocol (VoIP) communications devices, and devices corresponding to the Internet of things (e.g., wireless sensors, wireless appliances, wireless industrial, commercial, and household machines, etc.) have become increasingly popular. As these types of devices gain in popularity, a need to authenticate, verify, and/or validate such electronic communication devices, and subscribers of these devices and/or their attendant services, for example, who may be frequently co-located with such communication devices, also increases. Authentication of electronic communications devices may be especially beneficial in environments that facilitate financial transactions utilizing such wireless communications devices. Financial transactions may involve completing applications for credit, conveying or receiving funds (e.g., “wiring”) between or among bank accounts, purchasing products and/or services, obtaining access to privileged content, completing loan applications, completing forms involved with applying for healthcare coverage (such as in connection with visiting a healthcare provider's office), and/or engaging in any number of other types of transactions via a communications device. In other environments, such as environments involving IOT devices, verification of the identity of an individual attempting to remotely operate a sensor, an appliance, a machine, an instrument, for example, in which output signals from such devices may be utilized to drive numerous decision-making processes.

To facilitate transactions involving users operating communications devices, for example, a subscriber co-located with, or otherwise affiliated with, a communications device, may establish an identity in connection with a communications device subscriber account with, for example, a cellular or mobile wireless communications services carrier, a VoIP services provider, or other type of communication services carrier. Establishing an account associated with a communications device, utilizing, for example, a subscriber account identifier (e.g., a cellular telephone number, a universally unique identifier or UUID, etc.), may permit an individual seeking to engage in an electronic or digital transaction to be authenticated, authorized, and/or verified prior to engaging in the transaction. In other instances, a medical facility may seek to verify the identity of a patient (or potential patient) seeking medical care, so as to reduce the possibility of insurance fraud, Medicare fraud, etc. In some instances, in view of the nature of electronic or digital transactions, such as in environments in which electronic or digital transactions can be initiated via a communications network at any time and at any location, it may be useful to verify and/or authenticate a communications device, and/or a user of a communications device (e.g., a subscriber), relatively quickly, such as in a real-time or near-real-time manner, for example.

In a financial services environment, for example, authentication and/or verification of the identity of an account holder operating, or at least co-located with, a communication device may be desirable in response to a client institution or organization (e.g., a financial institution, a brokerage, a healthcare provider, content provider, etc.) seeking to determine and/or prove identity of the account holder prior to permitting access to the account holder's financial assets. Authentication and/or verification of the identity of a subscriber operating a communications device may involve establishing a bind between an authenticating entity and a real-world identity of a subscriber operating a communications device and/or a subscriber associated with one or more IOT devices. In such contexts, a subscriber account identifier, which may exist in a digital domain, may operate to establish a persistent, continuing, and objectively verifiable correspondence or affiliation between a communications device and a subscriber in possession of, or at least associated with, a particular communications device. Thus, in a financial services environment, for example, a unique subscriber account identifier (e.g., a mobile telephone number) may be employed to signify the identity of a particular account holder.

As used herein, the terms “mobile communications device services provider,” “mobile communications device carrier,” and “mobile network operator” may be used interchangeably. Additionally, in this context, the term “mobile device services carrier,” “communication services carrier,” “services carrier,” or simply “carrier” may refer to an entity operating within a communications infrastructure to provide wired and/or wireless communication services to the public for a consideration, such as a monthly subscription fee.

In the context of the present disclosure, a “communication services carrier” refers to a mobile communication services provider and/or a mobile network operator. However, there are examples of carriers that do not correspond to mobile communications device services providers and/or mobile network operators. Such instances may include wireline services providers (for example, providers of services operating within the public switched telephone network or PSTN), which include wireline services for rotary-dial telephones and/or telephones utilizing, for example, dual tone multi-frequency (DTMF) signaling. Accordingly, the terms “services carrier” or simply “carrier” may be used in place of a communication services provider and/or wireline telephone services provider without a loss in meaning and/or understanding. In a given situation, particular context of usage should indicate if a term is being used in a general sense or in a narrower sense, such as referring to a mobile communications device services provider, wireline services provider, mobile paging services provider, and/or mobile network operator, for example.

Other aspects of verifying and/or authenticating the identity of an account holder operating, or at least co-located with, a communication device (e.g., a mobile communications device, an IOT device, etc.) are also described in greater detail hereinbelow. For example, in an embodiment, verifying the identity and/or authenticating a subscriber or an account holder of an a communications device or an IOT device, may bring about establishment of a bind between an individual and an account. Further, a mobile subscriber account is merely an example approach toward establishing a correspondence between an individual and a communications device, and claimed subject matter is not intended to be limited to accounts established for mobile cellular communications devices and IOT devices. Rather, the term “account” or “subscriber account” in this context refers generally to a business arrangement between a provider of the account and an entity, a person, or other party seeking to obtain privileges associated with the account. Thus, the term “account” is intended to be broadly interpreted as an arrangement that may provide certain privileges. In this context, privileges may involve access to credit (e.g., so as to facilitate the present or future purchase of goods or services), access to privileged content (e.g., such as premium sports, cinema, or other entertainment content), access to health records, access to financial records, access to financial and/or brokerage accounts, access to parameters transmitted by IOT devices, an ability to control operation of IOT devices, and so forth. In this context, the term “privileged content” is intended to be interpreted broadly so as to encompass any type of content available exclusively to certain individuals and/or certain entities in response to supplying certain credentials to a bank or financial institution, an IOT device, a mobile communication services provider, and so forth.

Likewise, an account may comprise various attributes. For example, in the context of a mobile cellular communications device (e.g., a mobile telephone), the term “subscriber account identifier,” which may comprise a mobile telephone number, refers to a unique descriptor or feature associated with the account that defines certain aspects of the account. For example, in nonlimiting illustrations, a subscriber account identifier may refer to (or may at least be associated with) a mobile telephone number, a mobile subscriber unique alias, an International Mobile Subscriber Identifier (IMSI), Integrated Circuit Card Identifier (ICC ID), a mobile services and/or other type of identifier (e.g., a unique identifier) employed in connection with the particular mobile network operator or the mobile communication services provider. Mobile communications networks may include those compatible or compliant with a Global System for Mobile Communications (GSM) network, for example. Other examples of mobile subscriber account identifiers may include an International Mobile Equipment Identifier (IMEI), Mobile Station International Subscriber Directory Number (MSISDN), an international mobile subscriber identifier (IMSI), or any other identifier that may be utilized to identify a mobile billing account number/identifier. In the context of an IOT device, a combination of alphanumeric characters (which may function as a subscriber account identifier) may identify an individual authorized to receive or access parameters transmitted from the IOT device. The same or a different combination of alphanumeric characters may identify an individual authorized to modify/influence parameter settings of an IOT device.

As discussed herein, in a financial services environment, a subscriber associated or affiliated with a communications device may apply for an account, such as a credit account, for example, or may apply for any other type of account that imparts or confers one or more privileges on the subscriber co-located or in possession of the communications device. In other instances, a subscriber co-located with a mobile communications device may seek to engage in a financial transaction, for example, or may attempt to access privileged information/privileged content, just to name a few possible examples. In still other instances, a subscriber may wish to configure or to obtain output parameters from an IOT device. In these and other instances, to obtain privilege, such as access to credit, access to privileged information (e.g., premium content streaming or other entertainment), to access configuration settings and/or output parameters from an IOT device, a mobile subscriber may be required to establish some type of credentials, such as via completion of an application (e.g., such as an application for an account), an application for credit, an application for an increase in credit, or may be invited to make another type of formal request, which involves the subscriber supplying subscriber-specific parameters. However, as previously alluded to, it may be advantageous for the subscriber, and for the institution or service providing privileges to the subscriber, for example, to verify or to prove that, indeed, the subscriber is in possession of, co-located with, or otherwise in association with, a particular communications device. By proving affiliation with a particular communications device, an institution (e.g., a financial institution, a premium content provider, etc.) may reduce the risk of an unscrupulous individual, for example, accessing privileged information, which may permit the unscrupulous individual to obtain sensitive parameters that could enable and fraudulent financial transaction to take place, penetrate an IOT network, impersonate a particular individual, or the like. Such fraudulent behavior may be made possible by an unscrupulous individual stealing another subscriber's mobile phone or identity, or by way of obtaining sensitive information that permits the unscrupulous individual to impersonate the subscriber. In certain instances, impersonation of another subscriber may permit an unscrupulous individual to withdraw funds from a subscriber's account, illegally obtain physical access to a subscriber's home (e.g., such as by unlocking a door controlled by an IOT device), and so forth.

Thus, in particular embodiments, authenticating the identity of an account holder operating, or at least co-located with, a communication device may permit an authenticating entity to prove that a verified and/or authenticated individual is attempting to engage in a transaction, attempting to access parameters from an IOT sensor, attempting to modify operation of an IOT device, or the like. Obtaining such proof may reduce the likelihood of an unscrupulous individual completing a fraudulent transaction, such as a transaction that involves a credit application, an increase in a credit line, a purchase, an asset sale, access to premium content, access to a subscriber's home or office, or to obtain any other type of privileges via fraud and/or deception.

Accordingly, in particular embodiments, to reduce a possibility of fraudulent access to privileged content, fraudulent access to an IOT device or network, fraudulent access to sensitive financial information, fraudulent engagement in financial transactions, or the like, a communications device may communicate with client computing resource. A client computing resource may correspond to a computing resource owned, operated, leased, or at least under the control of, for example, a bank or other type of financial institution, a content provider, a health care provider, and IOT services provider, etc., which may facilitate the client computing resource to authenticate the transacting party. The client computing resource may engage with an identity verifier, which may comprise a special-purpose computer or other type of computing entity, which may operate to provide identity verification and/or authentication services. Thus, a special-purpose computer may, responsive to receipt of a query from a client computing resource, may operate to verify and/or authenticate the transacting party based, at least in part, on parameters obtained via access to one or more electronic databases. In particular embodiments, the one or more electronic databases may facilitate generation of a trust score based, at least in part, on deterministic, historical events occurring with respect to a subscriber's communications device. In particular embodiments, a trust score may be inversely proportional to various deterministic, historical events that may occur with respect to the subscriber's communications device. Such deterministic, historical events may include whether a subscriber has recently reported a subscriber identifier (e.g., a mobile telephone number) from a first communication services carrier to a second communication services carrier. In particular embodiments, a subscriber who has ported (e.g., recently ported) a subscriber from a first communication services carrier to a second communication services may represent an increased risk, which may degrade a subscriber's trust score. In particular embodiments, a subscriber who has recently removed/replaced a subscriber identity module (SIM) of a communications device may represent an increased element of risk, which may degrade a subscriber's trust score. In particular embodiments, a subscriber who has recently reset an account password, such as by obtaining a one-time password from a communication services carrier, may represent an increased risk, which may degrade a subscriber's trust score. However, conversely, a subscriber who has been affiliated or associated with a particular subscriber identifier (e.g., a mobile telephone number) for a long period of time, which may be referred to as device tenure, may represent a decreased risk, which may enhance a subscriber's trust score. Other behaviors with respect to a subscriber's communications device may operate to positively impact risk which may, in turn, bring about decreases in a subscriber's trust score.

However, at times, in addition to deterministic, historical events occurring with respect to a subscriber's communications device, it may be useful for institutions (e.g., financial institutions) to verify and/or authenticate a subscriber based on real-time parameters. Such parameters may include biometric features of a subscriber, such as content related to an image, for example, of a portion of a subscriber's person. In particular embodiments, a portion of a subscriber's person may include the subscriber's face, which may include the subscriber's eyes, nose, mouth, ears, hairline, etc. Such content may be obtained, for example, via the subscriber photographing his or her own face, such by taking a “selfie” photo, which may be compared with second content related to the subscriber. In particular embodiments, second content related to the subscriber may comprise an image of a user document, such as a government-issued document. A government-issued document may comprise a driver's license, a passport, an identification card, a health-services identification, or other official document that includes an image of a portion of the subscriber's person (e.g., a subscriber's face). In particular embodiments, a subscriber may utilize a communications device to upload first content (e.g., an image of a portion of the subscriber's person) and second content (e.g., an image of a user document comprising a corresponding image of the portion of the subscriber's person). First and second content may be uploaded to an identity verifier which may perform a comparison between the first and second content to determine whether a match or correspondence exists or whether discrepancies between features of the first content and the second content meet or exceed a predetermined threshold. Responsive to an identity verifier determining whether parameters extracted from uploaded first content (e.g., a captured image of a portion of the subscriber's person) matching or corresponding with parameters extracted from second content (e.g., a captured image of a user document showing the same or a similar portion of the subscriber's person), an authenticator may verify the identity of the subscriber and, for example, permit a transaction to occur.

In particular embodiments, an identity verifier may analyze first content, such as an uploaded image of a portion of a subscriber's person (e.g., a subscriber's face or facial features) to extract an array (such as a one-dimensional array, a two-dimensional array, a three-dimensional array, and so forth) of feature vectors that at least partially characterize the portion subscriber's person. Similarly, an identity verifier may analyze second content, such as an uploaded image of a user document (e.g., a driver's license, passport, or other type of government-issued document) to extract an array of feature vectors that at least partially characterize the uploaded image of the second document. In particular embodiments, an identity verifier may additionally extract parameters available on a printed article comprising second content, such as the subscriber's date of birth, city of residence, physical address, and so forth. An array of feature vectors obtained from first content relevant to a subscriber may be compared with feature vectors obtained from second content to determine whether a match exists between the first and second content. In particular embodiments, an identity verifier may indicate a match between first and second content based on discrepancies between images of the first content in the second content being below predetermined upper thresholds.

In particular embodiments, an identity verifier may analyze first and second content (e.g., a captured image of a portion of a subscriber's person and a captured image of a government-issued document) to determine a quality of “aliveness,” which, in this context, refers to an analysis to determine whether an uploaded image comprises an image of an already-captured image (e.g., a picture of a picture). Analyses to determine aliveness of an image may comprise analysis of image resolution of a captured image of a portion of a purported subscriber's person, color and/or lighting balance of objects in the foreground a captured image relative to color balance of articles in a background portion of a captured image. In particular embodiments, an identity verifier may analyze second content (e.g., a captured image of a driver's license, passport, or other government-issued document) to determine whether particular security markings (e.g., watermarks) are present in an image. In particular embodiments, an identity verifier may utilize extracted parameters available on a printed article comprising the second content (e.g., subscriber's birthdate, city of residence, physical address) as a basis of comparison with stored parameters relative to the subscriber's account with a particular communication services carrier.

In particular embodiments, a subscriber may upload an image of a portion of the subscriber's person (e.g., the subscriber's face captured via a photograph that one has taken of oneself) as well as an image of a driver's license, passport, or other government-issued document responsive to obtaining a link to a resource (e.g., a uniform resource locator). Responsive to receipt of a link to the resource, the subscriber may be prompted to capture images of first content and second content, and to upload the images for analysis by an identity verifier. In particular embodiments, in addition to the communications device transmitting, such as wirelessly transmitting, first and second content, the communications device may additionally transmit parameters specific to the particular communications device, such as the device's subscriber identifier (e.g., mobile telephone number), the device's International Mobile Equipment Identifier (IMEI), the device's Mobile Station International Subscriber Directory Number (MSISDN), the device's international mobile subscriber identifier (IMSI), or any other identifier particular to the communications device that may be utilized to identify a mobile billing account number/identifier.

Thus, in particular embodiments, determination of a match or correspondence between first and second content, or a determination of a mismatch of one or more feature vectors extracted from first and second content being within predetermined limits, an identity verifier may provide an increased level of confidence that a purported subscriber operating a particular communications device is, indeed, a bona fide, legitimate account holder of the particular communications device. Such authentication, based on matching, correspondence with, or at least correlation above a predetermined threshold between the first and second content, utilized in conjunction with historical, deterministic events with respect to the particular communications device may further increase a level of confidence that a purported subscriber is the legitimate account holder of a communications device. In many instances, such multi-factor authentication may reduce instances of fraud involving financial transactions, access to credit, access to sensitive subscriber parameters, access to privileged content, access to unauthorized healthcare benefits, etc.

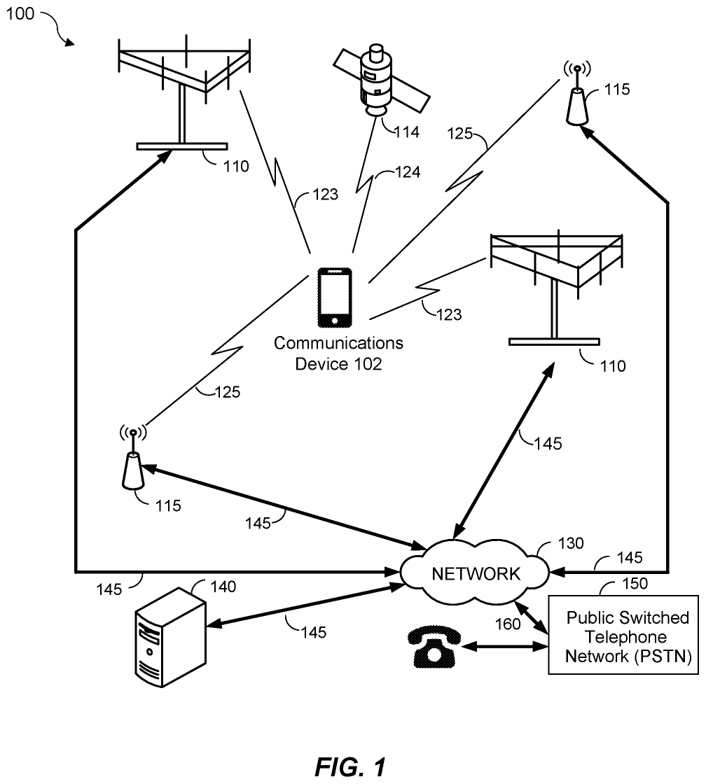

In FIG. 1, corresponding to embodiment 100, communications device 102 comprises a device designed primarily to conduct communications via wireless or wireline means, such as to provide mobile wireless telephone communications, texting, web browsing, and so forth. Communications device 102 may additionally correspond to certain types of IOT devices, such as devices which include imaging sensors (e.g., cameras), such as doorbell cameras, security cameras, or the like. In the embodiment of FIG. 1, communications device 102 may transmit radio signals to, and receive radio signals from, a wireless communications network. In an example, communications device 102 may communicate with a cellular communications network by transmitting wireless signals to, and/or receiving wireless signals from, a cellular transceiver 110, which may comprise a wireless base transceiver subsystem, a Node B or an evolved NodeB (eNodeB), over wireless communication link 123. Similarly, communications device 102 may transmit wireless signals to, and/or receive wireless signals from, local transceiver 115 over wireless communication link 125. A local transceiver 115 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network, such as those discussed herein). Of course, it should be understood that these are merely examples of networks that may communicate with a mobile device over a wireless link, and claimed subject matter is not limited in this respect. In particular embodiments, cellular transceiver 110, local transceiver 115, satellite 114, and PSTN 150 represent touchpoints, which permit communications device 102 to interact with network 130.

Examples of network technologies that may support wireless communication link 123 are GSM, Code Division Multiple Access (CDMA), Wideband CDMA (WCDMA), Long Term Evolution LTE), High Rate Packet Data (HRPD). GSM, WCDMA and LTE are technologies defined by 3GPP. CDMA and HRPD are technologies defined by the 3^{rd} Generation Partnership Project 2 (3GPP2). WCDMA is also part of the Universal Mobile Telecommunications System (UMTS) and may be supported by an HNB. Cellular transceivers 110 may comprise deployments of equipment providing subscriber access to a wireless telecommunication network for a service (e.g., under a service contract). In the embodiment of FIG. 1, a cellular transceiver 110 may perform functions of a cellular base station in servicing communications devices within a cell determined based, at least in part, on a range at which the cellular transceiver 110 is capable of providing access service. Examples of radio technologies that may support wireless communication link 125 include IEEE 802.11, Bluetooth, long-term evolution, 5G wireless networks, etc.

In a particular implementation, cellular transceiver 110 and local transceiver 115 may communicate with server 140, such as by way of network 130 via communication links 145. Here, network 130 may comprise any combination of wired or wireless links and may include cellular transceiver 110 and/or local transceiver 115 and/or server 140. In a particular implementation, network 130 may comprise Internet Protocol (IP) or other infrastructure capable of facilitating communication between communications device 102 at a call source and server 140 through local transceiver 115 or cellular transceiver 110. In an embodiment, network 130 may also facilitate communication between communications device 102, server 140 and a PSTN 150, for example through communications link 160. In another implementation, network 130 may comprise a cellular communication network infrastructure such as, for example, a base station controller or packet based or circuit based switching center (not shown) to facilitate mobile cellular communication with communications device 102. In a particular implementation, network 130 may comprise local area network (LAN) elements such as WiFi APs, routers and bridges and may, in such an instance, comprise links to gateway elements that provide access to wide area networks such as the Internet. In other implementations, network 130 may comprise a LAN and may or may not involve access to a wide area network but may not provide such access to communications device 102. In some implementations, network 130 may comprise multiple networks (e.g., one or more wireless networks and/or the Internet). In one implementation, network 130 may include one or more serving gateways or Packet Data Network gateways. In addition, one or more of server 140 may comprise an E-SMLC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) of network 130.

In particular embodiments, communications between communications device 102 and cellular transceiver 110, satellite 114, local transceiver 115, and so forth may occur utilizing signals communicated across wireless communications channels. Accordingly, the term “signal” may refer to communications utilizing propagation of electromagnetic waves across wireless or wireline communications channels. Signals may be modulated to convey messages utilizing one or more techniques such as amplitude modulation, frequency modulation, binary phase shift keying (BPSK), quaternary phase shift keying (QPSK) along with numerous other modulation techniques, and claimed subject matter is not limited in this respect. Accordingly, as used herein, the term “messages” refers to parameters, such as binary signal states, which may be encoded in one or more signals using one or more of the above-identified modulation techniques.

In particular implementations, and as discussed below, communications device 102 may comprise circuitry and/or processing resources capable of obtaining location related measurements (e.g. for signals received from GPS or other Satellite Positioning System (SPS) satellites 114), cellular transceiver 110 or local transceiver 115 and possibly computing a position fix or estimated location of communications device 102 based on these location related measurements. In some implementations, location related measurements obtained by communications device 102 may be transferred to a location server such as an enhanced serving mobile location center (E-SM LC) or SUPL location platform (SLP) (e.g. which may comprise a server, such as server 140) after which the location server may estimate or determine an estimated location for communications device 102 based on the measurements. In the presently illustrated example, location related measurements obtained by communications device 102 may include measurements of signals 124 received from satellites belonging to an SPS or Global Navigation Satellite System (GNSS) such as GPS, GLONASS, Galileo or Beidou and/or may include measurements of signals (such as 123 and/or 125) received from terrestrial transmitters fixed at known locations (e.g., such as cellular transceiver 110).

Communications device 102 or a separate location server may obtain a location estimate for communications device 102 based on location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT and OTDOA), pseudoranges or timing differences may be measured at communications device 102 relative to three or more terrestrial transmitters fixed at known locations or relative to four or more satellites with accurately known orbital data, or combinations thereof, based at least in part, on pilots, positioning reference signals (PRS) or other positioning related signals transmitted by the transmitters or satellites and received at communications device 102. Here, server 140 may be capable of providing positioning assistance data to communications device 102 including, for example, information regarding signals to be measured (e.g., signal timing), locations and identities of terrestrial transmitters and/or signal, timing and orbital information for GNSS satellites to facilitate positioning techniques such as A-GNSS, AFLT, OTDOA and E-CID. For example, server 140 may comprise an almanac to indicate locations and identities of cellular transceivers and/or local transceivers in a particular region or regions such as a particular venue, and may provide information descriptive of signals transmitted by a cellular base station or AP such as transmission power and signal timing. In the case of E-CID, communications device 102 may obtain measurements of signal strengths for signals received from cellular transceiver 110 and/or local transceiver 115 and/or may obtain a round trip signal propagation time (RTT) between communications device 102 and a cellular transceiver 110 or local transceiver 115. A communications device 102 may use these measurements together with assistance data (e.g. terrestrial almanac data or GNSS satellite data such as GNSS Almanac and/or GNSS Ephemeris information) received from server 140 to determine a location estimate for communications device 102 or may transfer the measurements to server 140 to perform the same determination. A call from communications device 102 may be routed, based on the location of communications device 102, and connected to PSTN 150, for example, via wireless communication link 123 and communications link 160.

A mobile device at a call source (e.g., communications device 102 of FIG. 1) may be referred to by any name corresponding to a cellphone, smartphone, laptop, tablet, PDA, tracking device, IOT device, or some other portable or movable device. Typically, though not necessarily, a mobile device may support wireless communication such as using GSM, WCDMA, LTE, CDMA, HRPD, wireless Fidelity (Wi-Fi), Bluetooth, WiMax, 5G etc. A mobile device may also support wireless communication using a wireless LAN (WLAN), DSL or packet cable, for example. A communications device may comprise a single entity or may comprise multiple entities such as in a personal area network where a user may employ audio, video and/or data I/O devices and/or body sensors and a separate wireline or wireless modem. An estimate of a location of a mobile device (e.g., communications device 102) may be referred to as a location, location estimate, location fix, fix, position, position estimate or position fix, and may be geographic, thus providing location coordinates for the mobile device (e.g., latitude and longitude) which may or may not include an altitude component (e.g., height above sea level, height above or depth below ground level, floor level or basement level).

Responsive to communications device 102 comprising a mobile cellular communications device, device 102 may comprise an embedded sensor suite which may, for example, include inertial sensors and environment sensors. Inertial sensors of communications device 102 may comprise, for example accelerometers (e.g., collectively responding to acceleration of communications device 102 in and x-direction, a y-direction, and/or a z-direction). Communications device 102 may further include one or more gyroscopes or one or more magnetometers (e.g., to support one or more compass applications). Environment sensors of communications device 102 may comprise, for example, temperature sensors, barometric pressure sensors, ambient light sensors, camera imagers, microphones, just to name few examples. Sensors of communications device 102 may generate analog or digital signals that may be stored in utilizing one or more memory locations internal to device 102 in support of one or more applications such as, for example, applications collecting or obtaining biometric attributes of a user (e.g., a subscriber) of communications device 102.

The architecture of the cellular communications network described in relation to FIG. 1 may comprise a generic architecture that is capable of accommodating a variety of outdoor and indoor location solutions including the standard SUPL user plane location solution defined by the Open Mobile Alliance (OMA) and standard control plane location solutions defined by 3GPP and 3GPP2. For example, server 140 may function as (i) a SUPL location platform to support the SUPL location solution, (ii) an E-SMLC to support the 3GPP control plane location solution with LTE access on wireless communication link 123 or 125, or (iii) a Standalone Serving Mobile Location Center (SAS) to support the 3GPP Control Plane Location solution for UMTS.

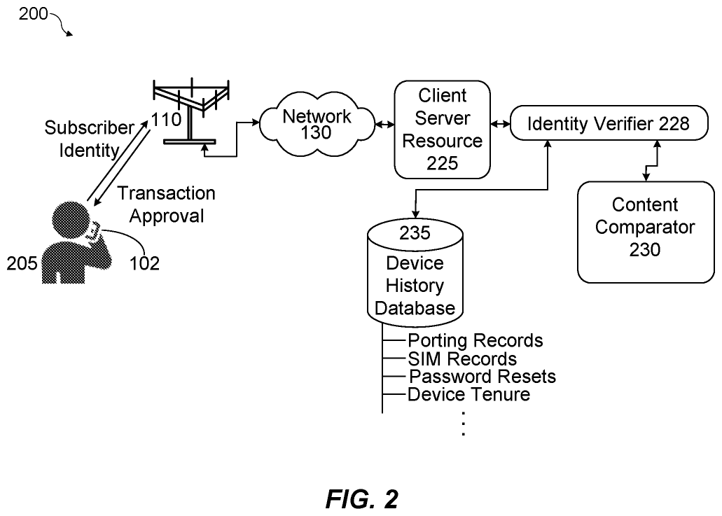

In view of the communications infrastructure shown and described in reference to FIG. 1, more particular embodiments directed toward identity verification utilizing uploaded content and trust score are discussed hereinbelow. Thus, embodiment 200 (FIG. 2) shows a subscriber in possession of communications device 102, which may comprise a mobile cellular communications device. Communications device 102 may interact with client computing resource 225 and identity verifier 228. In the embodiment of FIG. 2, mobile subscriber 205 and/or communications device 102 may be located at any point within communications range of cellular transceiver 110. Communications device 102 may communicate with client computing resource 225 via network 130 utilizing a wireless communications channel between the communications device and cellular transceiver 110. It should be noted, however, that claimed subject matter is not limited exclusively to wireless communications between communications device 102 and cellular transceiver 110. For example, in particular embodiments, communications device 102 may communicate with client computing resource 225 by way of one or more intervening Wi-Fi networks or by way of wireline telephone services (e.g., the public switched telephone network).

Subscriber 205, utilizing communications device 102, may attempt to engage in a financial transaction, such as via client computing resource 225. Client computing resource 225 may represent or signify a bank (or other type of financial institution), a real estate title company, a healthcare provider, a content provider, or any other type of entity that may, at least from time to time, require (or least initiate) verification, authentication, and/or auditing of communications device 102 prior to facilitating a transaction. In an alternative embodiment, communications device 102 may represent an IOT device, which may operate to transmit output signals representing, for example, images captured via an imaging device (e.g., camera), which may be utilized by a client computing resource to facilitate decision-making processes other than those of a financial nature, such as to support processes involving, for example, other types of IOT devices.

Subscriber 205 may operate communications device 102 to initiate a transaction involving client computing resource 225. In response to subscriber 205 attempting to initiate a financial transaction, client computing resource 225 may communicate with identity verifier 228, which may operate to authenticate, verify, and/or audit subscriber 205 operating communications device 102. In the embodiment of FIG. 2, authentication, verification, and/or auditing of subscriber 205 may include identity verifier 228 accessing device database 235, which may store historical records of deterministic events with respect to communications device 102. Such records may represent events that may be regarded by client computing resource 225 as representing particular levels of trustworthiness (e.g., as embodied in a trust score) of subscriber 205. In particular embodiments, identity verifier 228 may assess trustworthiness of subscriber 205 via examining porting records stored in device history database 235. Porting records may relate to a frequency of subscriber 205 porting a subscriber identifier (e.g., a mobile telephone number) of communications device 102, so as to switch from a first communication services carrier to a second communication services carrier. Identity verifier 228 may additionally assess trustworthiness of subscriber 205 via examining records stored in device history database 235 that may relate to whether subscriber 205 has recently removed/replaced a SIM or eSIM of a communications device. Identity verifier 228 may additionally assess trustworthiness of subscriber 205 via examining records stored in device history database 235, which may relate to occurrences of password resets, such as indicated via transmission of one-time passwords to communications device 102. Identity verifier 228 may assess trustworthiness of subscriber 205 via examining records stored in device database 235, which may relate to tenure of communications device 102, which may indicate a duration that subscriber 205 has owned, operated, or has otherwise been affiliated with device 102. It should be noted that claimed subject matter is intended to embrace additional contributors to a trustworthiness score or trustworthiness measure, which may be stored in device history database 235, virtually without limitation.

In the embodiment of FIG. 2, prior to facilitating engagement of subscriber 205 in a financial transaction via client computing resource 225, identity verifier 228 may establish or form a secure channel between itself and communications device 102. Thus, identity verifier 228 may initiate a browser-based Internet session between the identity verifier and the communications device. Thus, in particular embodiments, in response to communications device 102 transmitting a subscriber identifier, which may comprise, for example, a mobile telephone number, identity verifier 228 may generate and transmit a tailored resource locator (e.g., a specially formulated URL), which may be conveyed to communications device 102 via client computing resource 225, network 130, and cellular transceiver 110. In response to obtaining the URL generated by identity verifier 228, communications device 102 may be directed to initiate a browser-based Internet session directly with identity verifier 228.

Although not explicitly depicted in FIG. 2, during a browser-based session, identity verifier 228 may transmit a request to communications device 102, which may operate to prompt subscriber 205 to capture first content and second content, which may assist identity verifier 228 in verifying the identity of subscriber 205. Thus, in particular embodiments, identity verifier 228 may, via a browser-based wireless session established between communications device 102 and identity verifier 228, request an upload of a captured image of first content, which may comprise an image of a portion of subscriber 205's person. In particular embodiments, the portion of subscriber 205 may correspond to the subscriber's face, which may include one or more of the subscriber's ears, eyes, as well as the subscriber's nose and mouth, or any other facial features. The of the browser-based session, communications device 102 may transmit the image of the portion of the subscriber's person to identity verifier 228. Identity verifier 228 may additionally request an upload of a captured image of second content, which may comprise an image of a user document, such as a driver's license, passport, identification card, or any other government-issued document. Responsive to receipt of first and second content by identity verifier 228, content comparator 230 may determine whether a match, or predetermined threshold level of correspondence, exists between the uploaded, captured image of a portion of the subscriber's person and a related image of the subscriber's person depicted on the government-issued document. In particular embodiments, content comparator 230 may additionally extract non-image-related parameters from an image of an uploaded government-issued document, such as the subscriber's name, physical address (or one or more aspects thereof), and claimed subject matter is not limited in this respect.

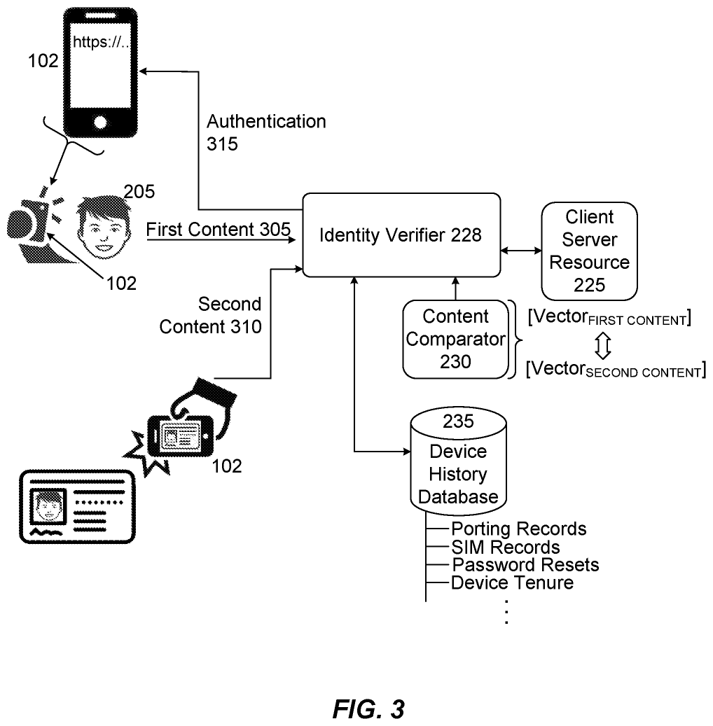

FIG. 3 is a diagram of a subscriber obtaining first and second content to facilitate identity verification utilizing uploaded content and a trust score, according to an embodiment. In embodiment 300 shown in FIG. 3, subscriber 205 is shown operating communications device 102 so as to capture first content 305 which, in this instance, comprises an image of a portion of the subscriber's person. Subscriber 205 may be prompted to capture first content 305 responsive to establishing a browser-based session between communications device 102 and identity verifier 228. Such a browser-based session may be established in response to identity verifier 228 verifying the identity of and/or authenticating subscriber 205. As mentioned in reference to FIG. 2, such identity verification/authentication may facilitate subscriber 205 to engage in a financial transaction with a financial institution associated with client computing resource 225 (of FIG. 2).

In this instance, subscriber 205 is shown taking a picture of his or her facial features (e.g., a “selfie”), including both ears, both eyes, the subscriber's nose and mouth. In particular embodiments, identity verifier 228 may provide instructions to subscriber 205, such as by providing a transparent template or outline (not shown in FIG. 3), so as to indicate a range of distances that the subscriber's face or other feature should be from a camera lens, for example, of communications device 102. In some instances, identity verifier 228 may provide instructions to subscriber 205 to include, for example, whether an image should be captured from a point directly in front of the subscriber's face, for example, to the left side of the subscriber's face, to the right side of the subscriber's face, so as to include the subscriber's right ear, left ear, or other aspect of the subscriber's face, head, and/or neck. Identity verifier may provide other instructions, such as whether to activate a camera flash, background lighting level, foreground lighting level, or any other image-capture considerations, and claimed subject matter is not limited in this respect.

Responsive to subscriber 205 uploading a captured image of first content 305, subscriber 205 may be prompted by identity verifier to upload a captured image of second content 310, which may comprise an image of a driver's license, a passport, an identification card or any other government-issued user document. It should be noted, however, that in certain settings identity verifier may prompt subscriber 205 to upload a captured image of second content 310 comprising other user documents, such as company-issued identification cards or badges, government-issued immigration/naturalization documents, health insurance cards, or any other authoritative documents that include an image of a portion of subscriber 205's person. In some instances, identity verifier 228 may provide instructions to subscriber 205 to include, for example, whether a captured image of second content 310 is recommended to be captured from a particular distance or between a range of distances, from the document, whether front and back sides of documents are to be imaged, a type of background surface upon which second content 310 should be placed, or any other considerations, and claimed subject matter is not limited in this respect.

Responsive to an upload of first content 305 and upload of second content 310, identity verifier 228 may determine whether a match, or correspondence above a predetermined threshold level, exists or whether discrepancies between features of the first content and the second content are within predetermined limits. In particular embodiments, such predetermined limits may relate to relative size of one or more features of the subscriber's person relative to other features of the subscriber's person, such as size of a subscriber's ear relative to a distance between the subscriber's eyes, distance between the subscriber's relative to distance between one of the subscriber's eyes to the subscriber's mouth, as well as a host of other dimensional parameters relating to particular aspects of the subscriber's person, and claimed subject matter is not limited in this respect. Responsive to an identity verifier 228 determining whether parameters extracted from uploaded first content (e.g., a captured image of a portion of the subscriber's person) matching (or establishing a correspondence between) parameters extracted from second content (e.g., a captured image of a user document showing the same or a similar portion of the subscriber's person), an authenticator may verify the identity of the subscriber and, such as, for example, by way of an authentication signal 315, which may indicate that a requested transaction is permitted to occur. Alternatively, or in addition to, an authentication signal may be transmitted from identity verifier 228 to client/server resource 225 to indicate that a requested transaction may be permitted to occur. In particular embodiments, rather than transmit an approval that permits a particular transaction to occur, identity verifier 228 may instead transmit a trust score to client server resource 225, which may facilitate use of client-specific business rules and/or business logic to determine whether a particular transaction is to occur.

As shown in FIG. 3, content comparator 230 may utilize feature vectors extracted from first content (e.g., an uploaded image of a subscriber's face) and second content (e.g., an uploaded image of a subscriber's driver's license), so as to facilitate a comparison between the first content and the second content. In the embodiment of FIG. 3, content comparator 230 may form an array of feature vectors, which may comprise a one-dimensional array, a two-dimensional array, a three-dimensional array, or an array of any other dimension, that sufficiently characterizes, or reduces to appropriate parameters, the first and second content. Hence, components of feature vectors representing first content and second content may be compared, which may facilitate determination of whether differences between individual components of feature vectors are within predetermined threshold values. In some instances, such predetermined threshold values, such as size of a subscriber's ear relative to a distance between the subscriber's eyes as extracted from first content may be compared with corresponding values extracted from second content. In particular embodiments, distance between various features of the subscriber's person, such as distance between one of the subscriber's eyes to the subscriber's mouth as extracted from first content may be compared with corresponding values extracted from second content. In particular embodiments, based, at least in part, on differences between corresponding features extracted from first and second content being lower than threshold values, such as 1%, 5%, 10%, or any other appropriate threshold, prior to allowing a transaction to occur. It should be noted that claimed subject matter is intended to embrace any appropriate predetermined threshold values representing differences between feature vectors extracted from first and second content.

Identity verifier 228 may additionally employ optical character recognition, which may facilitate extraction of non-image-based parameters of uploaded captured image of second content. For example, responsive to upload of a subscriber's driver's license or other government-issued document, identity verifier 228 may extract the subscriber's printed name, printed physical address (e.g., street address, city, state/province, ZIP Code or other postal code, country, etc.). Identity verifier 228 may then determine whether such non-image-based parameters accord with account parameters stored by a communication services carrier to communications device 102. In particular embodiments, identity verifier 228 may utilize one or more of a subscriber account identifier (e.g., a subscriber mobile telephone number) or any other type of device-specific parameter, such as a UUID, a subscriber account identifier (e.g., a mobile telephone number), an IMEI, a MSISDN, an IMSI, an ICC ID, or a unique alias assigned by an identity verifier (e.g., identity verifier 228). Device-specific parameters may serve to notify an identity verifier of the specific communications device attempting, for example, to obtain authentication via the identity verifier.

As previously noted in regards to the discussion of FIG. 2, identity verifier 228 may assess trustworthiness of subscriber 205 via examining records of historical, deterministic events stored in device history database 235. Such records may relate to whether subscriber 205 has recently ported a subscriber identifier of communications device 102, whether subscriber 205 has removed/replaced a SIM of device 102, whether subscriber 205 has recently reset a password associated with device 205, tenure of device 205, as well as various other historical, deterministic events, and claimed subject matter is not limited in this respect.

Thus, it may be appreciated that identity verifier may utilize records relating to historical, deterministic events relative to communications device 102 as well as real-time parameters, such as parameters extracted from first content (e.g., an uploaded image of a portion of the subscriber's person) as a basis of comparison with parameters extracted from second content (e.g., an uploaded image of a portion of the subscriber's driver's license, passport, etc.) to complement a trustworthiness metric (e.g., a trust score). In doing so, a financial institution, premium content provider, healthcare provider, etc., may obtain greater assurance that subscriber 205, having been verified as an account holder for telecommunication services associated with device 102, has proven his or her identity. By obtaining an increased level of proof and the authenticity of subscriber 205, financial transactions (as well as other types of transactions) may proceed via communications device 102 with a decreased risk that subscriber 205 is engaging in fraudulent behavior.

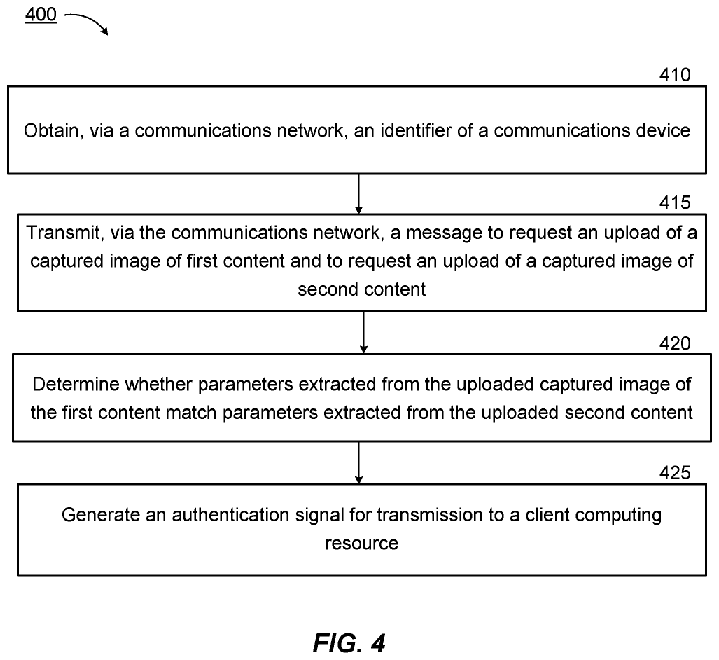

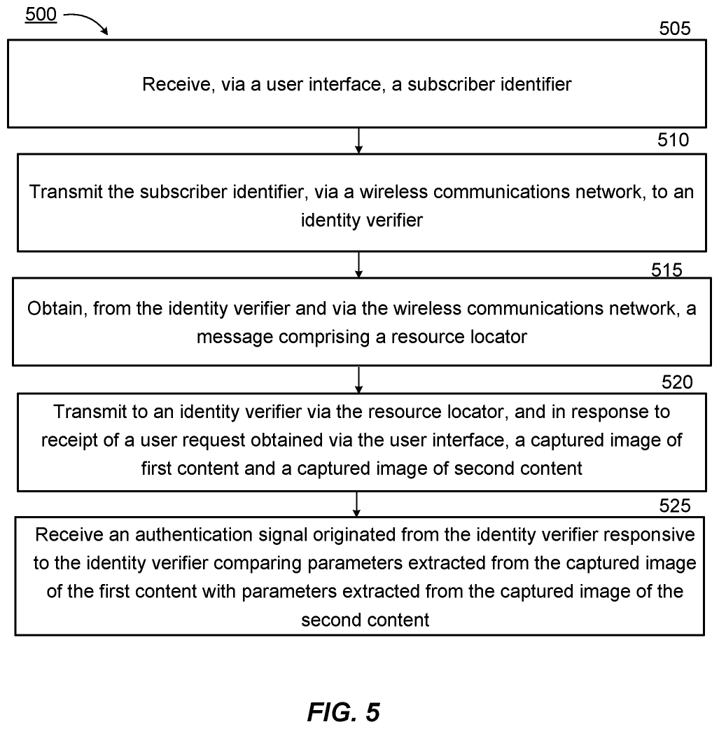

FIG. 4 shows a flowchart for a process of identity verification utilizing uploaded content and a trust score, according to an embodiment 400. It should be noted that the disclosed embodiments, such as the embodiments of FIGS. 4, and 5, are intended to embrace numerous variations, including methods that may include actions in addition to those depicted in the figures, actions performed in an order different than those depicted in the figures, as well as methods including fewer steps than those depicted. The method of FIG. 4 begins at 410, which includes an identity verifier (e.g., identity verifier 228), initiating an authentication process via obtaining, via a communications network, an identifier of a communications device. An identifier may comprise a mobile telephone number, a mobile subscriber unique alias, an International Mobile Subscriber Identifier (IMSI), Integrated Circuit Card Identifier (ICC ID), a mobile services and/or other type of identifier (e.g., a unique identifier) employed in connection with the particular mobile network operator and/or the mobile communication services provider.

The method of FIG. 4 may continue at 415, which may include transmitting, via the communications network, a message to request an upload of a captured image of first content and to request an upload of a captured image of second content. First content may comprise an image of a portion of the subscriber's person (e.g., an image of a subscriber captured by him or herself that encompasses at least a significant portion of the subscriber's face). Second content may comprise a subscriber document, such as a driver's license, a passport, an identification card, a healthcare ID card, or any other government-issued document (or even a private company-issued document). The method may continue at 420, which may include determining whether parameters extracted from the uploaded captured image of the first content match (or sufficiently correspond with) parameters extracted from the uploaded second content. Alternatively, 420 may include determining whether differences between one or more components of a feature vector representing parameters extracted from first content are within predetermined limits of one or more components of a feature vector representing parameters extracted from second content. The method may continue at 425, which may include generating an authentication signal for transmission to a client computing resource responsive to the outcome of 420.

FIG. 5 shows a flowchart for a process of identity verification utilizing a communications device to upload content to an identity verifier, according to an embodiment 500. The method of FIG. 5 may operate from the perspective of a communications device, such as communications device 102. The method of FIG. 5 may begin at 505, which may include receiving, via a user interface, a subscriber identifier. A subscriber identifier may include, for example, a mobile telephone number. In particular embodiments, FIG. 5 may exclude 505 in favor of a subscriber identifier being accessed from a memory location within a communications device for transmission, such as at 510, via a wireless communications network to an identity verifier. Alternatively, or in addition to, 510 may include transmission to an identity verifier of other identifiers extracted or derived from a memory device within a mobile communications device, such as an International Mobile Subscriber Identifier (IMSI), Integrated Circuit Card Identifier (ICC ID), a mobile services and/or other type of identifier, for example.

The method may continue at 515, which may include obtaining, from an identity verifier via the communications network, a message comprising a resource locator. A resource locator may include a URL, which may direct the communications device to establish a browser-based session with an identity verifier. Responsive to establishing a browser-based a session with an identity verifier, the communications device may transmit, such as at 520, a captured image of first content and a captured image of second content. Transmissions described at 515 may occur responsive to a request obtained via a subscriber operating the communications device in response to receiving one or more prompts originating from an identity verifier. The method may continue at 525, which may include receiving an authentication signal originated from the identity verifier. An authentication signal may be transmitted from the identity verifier responsive to a successful match (or a level of correspondence above a predetermined threshold) between first content and second content. A successful match or correspondence may be determined in response to comparison of feature vectors extracted from first content and second content. A successful match may result from determining that one or more components of a feature vector extracted from the first content are within predetermined limits of one or more components of a feature vectors extracted from the second content.

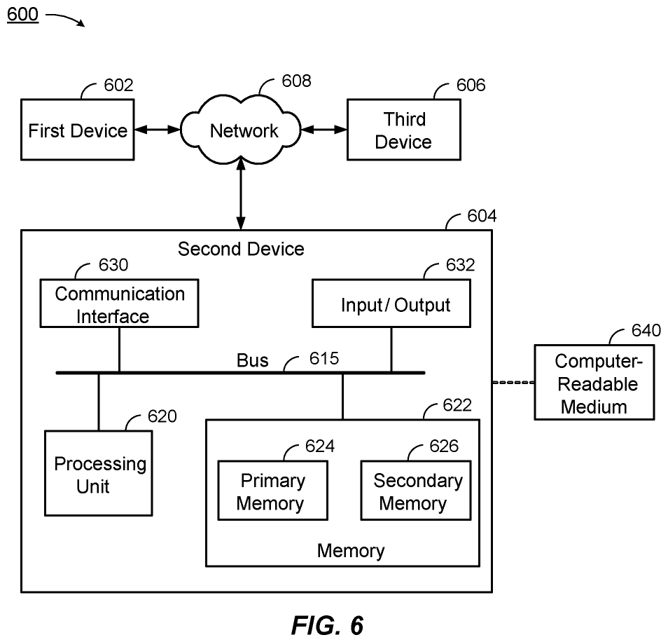

FIG. 6 is a diagram showing a computing environment, according to an embodiment 600. In the embodiment of FIG. 6, first device 602 may be capable of rendering a graphical user interface (GUI) for a network device receiving commands from a server device 140 of FIG. 1, so that a subscriber utilizing first device 602 (e.g., a mobile cellular communications device, an IOT device, etc.) may engage in system use. Device 604 may correspond to a computing resource under the control or direction of an identity verifier, such as identity verifier 228 of FIG. 2. Computing device 602 (‘first device’) may interface with computing device 604 (‘second device’ in FIG. 6), which may, for example, also comprise features of a client computing device and/or a server computing device, in an embodiment. Third device 606 may correspond to client/server resource 225, which operates under the direction and/or control of financial institution, for example. Second device 604 may comprise one or more processors (e.g., processing device) 620 and memory 622, which may comprise primary memory 624 and secondary memory 626, may communicate by way of a communication interface 630, for example. The term “computing device,” or “computing resource” in the context of the present patent application, refers to a system and/or a device, such as a computing apparatus that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Second device 604, as depicted in FIG. 6, is merely one example, and claimed subject matter is not limited in scope to this particular example.

In FIG. 6, first device 602, second device 604, and third device 606 may provide one or more sources of executable computer instructions in the form of physical states and/or signals (e.g., stored in memory states), for example. First device 602 may communicate with second device 604 by way of a network connection, such as via network 608, for example. As previously mentioned, a connection, while physical, may be virtual while not necessarily being tangible. Although second device 604 of FIG. 6 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 622 may of second device 604 comprise any non-transitory computer-readable medium. Memory 622 may comprise, for example, primary memory 624 and secondary memory 626, additional memory circuits, mechanisms, or combinations thereof may be used. Memory 622 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 622 may comprise one or more articles utilized to store a program of executable computer instructions. For example, processor 620 may fetch executable instructions from memory and proceed to execute the fetched instructions. Memory 622 may also comprise a memory controller for accessing device readable-medium 640 that may carry and/or make accessible digital content, which may include code, and/or instructions, for example, executable by processor 620 and/or some other device, such as a controller, as one example, capable of executing computer instructions, for example. Under direction of processor 620, a non-transitory memory, such as memory cells storing physical states (e.g., memory states), comprising, for example, a program of executable computer instructions, may be executed by processor 620 and able to generate signals to be communicated via a network, for example, as previously described. Generated signals may also be stored in memory, also previously suggested.

Memory 622 may store electronic files and/or electronic documents, such as relating to one or more users, and may also comprise a machine-readable medium that may carry and/or make accessible content, including code and/or instructions, for example, executable by processor 620 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted that an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

Processor 620 may comprise one or more circuits, such as digital circuits, to perform at least a portion of a computing procedure and/or process. By way of example, but not limitation, processor 620 may comprise one or more processors, such as controllers, micro-processors, micro-controllers, application specific integrated circuits, digital signal processors, programmable logic devices, field programmable gate arrays, the like, or any combination thereof. In various implementations and/or embodiments, processor 620 may perform signal processing, typically substantially in accordance with fetched executable computer instructions, such as to manipulate signals and/or states, to construct signals and/or states, etc., with signals and/or states generated in such a manner to be communicated and/or stored in memory, for example.

Second device 604 additionally includes component 632 operable with input/output devices, and communication bus 615, for example, so that signals and/or states may be appropriately communicated between devices, such as between first device 602, second device 604, and/or third device 606. A user may make use of an input device, such as a computer mouse, stylus, track ball, keyboard, touchscreen, and/or any other similar device capable of receiving user actions and/or motions as input signals. Likewise, for a device having speech to text capability, a user may speak to generate input signals. Likewise, a user may make use of an output device, such as a display, a printer, etc., and/or any other device capable of providing signals and/or generating stimuli for a user, such as visual stimuli, audio stimuli and/or other similar stimuli.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modeled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more communications devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a client server device and/or a communications device, as well as other types of devices, including between wired and/or wireless devices coupled via a wired and/or wireless network, for example.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a communications device and/or a client server device in various embodiments. Network devices capable of operating as a client server, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a communications device, as well as other types of devices, including between wired and/or wireless devices coupled via a wired and/or wireless network, for example, or any combination thereof. It is noted that the terms, server, server device, server computing device, server computing platform and/or similar terms are used interchangeably.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communications devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

The term electronic file and/or the term electronic document are used throughout this document to refer to a set of stored memory states and/or a set of physical signals associated in a manner so as to thereby, at least logically, form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted that an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is common. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). As suggested previously, a computing device and/or a networking device may also have a subscriber identity module (SIM) card, which, for example, may comprise a detachable or embedded smart card that is able to store subscription content of a subscriber, and/or is also able to store a contact list. It is noted, as previously mentioned, that a SIM card may also be electronic in the sense that it may simply be sorted in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a communications device application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
obtaining, via a communications network, an identifier of a communications device;
transmitting, via the communications network, a message to request an upload of a captured image of first content and to request an upload of a captured image of second content;
determining whether parameters extracted from the uploaded captured image of the first content match parameters extracted from the uploaded second content; and
generating an authentication signal for transmission to a client computing resource.

2. The method of claim 1, wherein the identifier of the communications device comprises a mobile telephone number.

3. The method of claim 1, wherein the transmitted message comprises a link to a resource that is under the control and/or direction of an identity verifier.

4. The method of claim 1 wherein the first content comprises a user document.

5. The method of claim 4, wherein the user document comprises a government-issued identification document.

6. The method of claim 5, wherein the government-issued identification document comprises a driver's license.

7. The method of claim 5, wherein the government-issued identification document comprises a passport.

8. The method of claim 1, wherein the second content comprises an image of a portion of the user's person.

9. The method of claim 8, wherein the portion of the user's person comprises at least a portion of the user's face.

10. The method of claim 1, further comprising:
determining that the identifier of the communications device comprises an identifier stored in a database accessible to an identity verifier.

11. The method of claim 10, wherein the parameters extracted from the user-uploaded captured image of the first content correspond to parameters of a subscriber identified by the identifier stored in the database.

12. The method of claim 11, further comprising determining that the identified subscriber corresponds to a holder of an account with respect to the communications device.

13. The method of claim 11, wherein generating the authentication signal is based, at least in part, on a trust score computed for the identified subscriber.

14. The method of claim 13, wherein the trust score is being computed responsive to a detection of a discrepancy detected between the parameters extracted from the first content and the parameters extracted from the upload of the captured image of the second content.

15. The method of claim 13 wherein the trust score being computed responsive to at least one of: determining validity of the user-uploaded captured image of the first content, detecting a discrepancy between the parameters extracted from the first content and the parameters of the subscriber identified by the identifier stored in the database, and detecting a risk associated with the subscriber identifier.

16. An apparatus comprising:
at least one processor coupled to at least one memory device to:
obtain, via a communications network, an identifier of a communications device;
transmit, via the communications network, a message to request an upload of a captured image of first content and to request an upload of a captured image of second content;
determine whether parameters extracted from the uploaded captured image of the first content match parameters extracted from the uploaded second content; and
generate an authentication signal for transmission to a client computing resource.

17. The apparatus of claim 16, wherein the identifier of the communications device comprises a mobile telephone number.

18. The apparatus of claim 16, wherein the transmitted message comprises a link to a resource that is under the control and/or direction of an identity verifier.

19. The apparatus of claim 16, wherein the first content comprises a government-issued identification document.

20. The apparatus of claim 16, wherein the second content comprises an image of a portion of the user's person and wherein, the portion of the user's person comprises at least a portion of the user's face.

21. The apparatus of claim 16, wherein the parameters extracted from the user-uploaded captured image of the first content correspond to parameters of a subscriber identified by an identifier stored in a database, and wherein generation of the authentication signal is based, at least in part, on a trust score computed for the identified subscriber.

22. An article comprising:
a non-transitory computer-readable medium comprising instructions encoded thereon which, in response to being executed by a computer processor coupled to at least one memory device, instruct the computer processor coupled to the at least one memory device to:
obtain, via a communications network, an identifier of a communications device;
transmit, via the communications network, a message to request an upload of a captured image of first content and to request an upload of a captured image of second content;
determine whether parameters extracted from the uploaded captured image of the first content match parameters extracted from the uploaded second content; and
generate an authentication signal for transmission to a client computing resource.

23. The article of claim 22, wherein the identifier of the communications device comprises a mobile telephone number.

24. The article of claim 22, wherein the transmitted message comprises a link to a computing resource that is under the control and/or direction of an identity verifier.

25. The article of claim 22, wherein the first content comprises a government-issued identification document.

26. The article of claim 22, wherein the second content comprises an image of a portion of the user's person and wherein, the portion of the user's person comprises at least a portion of the user's face.

27. The article of claim 22, wherein the parameters extracted from the user-uploaded captured image of the first content correspond to parameters of a subscriber identified by an identifier stored in a database, and wherein generating the authentication signal is based, at least in part, on a trust score computed for the identified subscriber.
